(19) United States
(12) Patent Application Publication
(10) Pub. No.: US 2023/0268882 A1
(43) Pub. Date: Aug. 24, 2023

(54) Device and System for I-V Measurement and Performance Analysis in a PV Array

(71) Applicants: Michael GOSTEIN, Austin, TX (US); William STUEVE, Austin, TX (US)

(72) Inventors: Michael GOSTEIN, Austin, TX (US); William STUEVE, Austin, TX (US)

(21) Appl. No.: 18/130,558

(22) Filed: Apr. 4, 2023

Related U.S. Application Data
(63) Continuation-in-part of application No. 17/739,823, filed on May 9, 2022.
(60) Provisional application No. 63/327,702, filed on Apr. 5, 2022.
(60) Provisional application No. 63/186,237, filed on May 10, 2021.

(51) Int. Cl. H02S 50/15

(52) U.S. Cl. CPC H02S 50/15

(57) ABSTRACT

In one respect, disclosed is a device comprising terminals or connections configured to connect to a first associated PV module, I-V measurement circuitry coupled to said terminals or connections and configured to measure I-V data of said first associated PV module, communication circuitry configured to communicate with at least one external device, and a processor coupled to said I-V measurement circuitry and to said communication circuitry, wherein said processor is configured to receive external data via said communication circuitry from said at least one external device, and wherein said processor is configured to determine a relative performance metric based at least upon said I-V data of said first associated PV module and said external data. In another respect, disclosed is a system comprising a first device configured to measure first I-V data of a first associated PV module and a second device configured to measure second I-V data of a second associated PV module, wherein said first device may be configured to receive said second I-V data and to determine a relative performance metric based at least upon said second I-V data and said first I-V data.

### CROSS-REFERENCE TO RELATED APPLICATIONS

This application is a continuation-in-part of U.S. patent application Ser. No. 17/739,823, filed May 9, 2022, which is incorporated by reference herein.

This application claims priority to U.S. Provisional Patent Application 63/186,237, filed May 10, 2021, and to U.S. Provisional Patent Application 63/327,702, filed Apr. 5, 2022, both of which are incorporated by reference herein.

### STATEMENT OF GOVERNMENT INTEREST

This invention was made with Government support under DE-SC0020012 awarded by the US Department of Energy. The Government has certain rights in this invention.

### FIELD OF THE INVENTION

The disclosed subject matter is directed to the measurement of current-voltage (I-V) characteristics and performance metrics of modules in photovoltaic (PV) arrays for solar energy production.

### BRIEF SUMMARY

In one respect, disclosed is a device configured to measure current-voltage (I-V) data of an associated photovoltaic (PV) module coupled to said device.

In another respect, disclosed is a device configured to measure I-V data of an associated PV module coupled to said device and in-situ or in-line within a PV array.

In another respect, disclosed is a device configured to measure I-V data of a first associated PV module coupled to said device, to receive data from an external device, and to determine a relative performance metric based at least upon measuring said I-V data of said first associated PV module and said data from said external device. In one embodiment, said data from said external device comprises I-V data of a second associated PV module coupled to said external device.

In another respect, disclosed is a system comprising a first device configured to measure I-V data of a first associated PV module, and a second device configured to measure I-V data of a second associated PV module, wherein said first device is configured to send said I-V data of said first associated PV module to said second device, and wherein said second device is configured to determine a relative performance metric based at least upon said I-V data of said first associated PV module and said I-V data of said second associated PV module.

### BRIEF DESCRIPTION OF THE DRAWINGS

FIG. 1 depicts an I-V unit (200) connected to a PV module device under test (101) which is part of a string (110) connected to a load or inverter (120), in accordance with some embodiments.

FIG. 2A depicts main components of an embodiment of an I-V unit (200), in accordance with some embodiments.

FIG. 2B depicts main components of an embodiment of an I-V unit (200), in accordance with some embodiments.

FIG. 3 depicts detailed components of an embodiment of an I-V unit (200), in accordance with some embodiments.

FIG. 4A depicts an exemplary I-V curve of a photovoltaic module operating within a string (110), in accordance with some embodiments.

FIG. 4B depicts a full sweep of an I-V curve in FIG. 4A using an embodiment of an I-V unit (200) depicted in FIG. 3, in accordance with some embodiments.

FIG. 4C depicts a mini sweep of an I-V curve in FIG. 4A using an embodiment of an I-V unit (200) depicted in FIG. 3, in accordance with some embodiments.

FIG. 4D depicts a mini sweep of an I-V curve in FIG. 4A using an embodiment of an I-V unit (200) depicted in FIG. 3, in accordance with some embodiments.

FIG. 4E depicts a mini sweep of an I-V curve in FIG. 4A using an embodiment of an I-V unit (200) depicted in FIG. 3, in accordance with some embodiments.

FIG. 5 depicts schematically the variation in the voltage of a module device under test (101) and I-V unit (200) output voltage during release sweep (440) indicated in FIG. 4C, in accordance with some embodiments.

FIG. 6A depicts schematically an embodiment employing multiple I-V units (200a, 200b, 200c) in which at least one unit receives data from another unit, in accordance with some embodiments.

FIG. 6B depicts schematically an embodiment employing multiple I-V units (200a, 200b, 200c) in which at least one unit receives data from another unit, in accordance with some embodiments.

FIG. 7 depicts schematically an embodiment employing multiple I-V units (200a) in which a unit (200a) receives data from auxiliary devices (602, 604), in accordance with some embodiments.

### BACKGROUND

Photovoltaic (PV) modules, also known as solar panels, are used to produce energy in solar energy installations, also known as solar power plants or PV power plants. PV power plants are comprised of a PV array, which is an array of PV modules, together with equipment to utilize the power produced by the modules. Such equipment could include a load powered by the array, an inverter to convert the power provided by the array to alternating current (AC) for immediate use or transmission, or an energy storage system. PV power plants, especially utility-scale or commercial-scale installations, frequently employ measurement systems for assessing and monitoring performance.

### DETAILED DESCRIPTION OF THE INVENTION

PV modules may be characterized by their I-V curve, the relationship between PV module output current and voltage, and parameters derived from the curve or associated with particular points on the curve. Key points on the I-V curve include short-circuit current (Isc), open-circuit voltage (Voc), maximum power point (MPP), maximum power (Pmax or Pmpp), maximum power point voltage (Vmp), and maximum power point current (Imp). Other points and values of interest may also be defined. I-V characteristics of a PV module (“I-V data”) may include any of the values defined in the preceding, additional values and metrics derived therefrom, and/or the entire I-V curve or a portion of an I-V curve. An I-V curve, or the process of measuring an I-V curve, may also be known as an “I-V sweep.”

Exemplary PV modules used in PV power plants have Isc between 2 amps and 30 amps, Voc between 20 volts and 300 volts, and Pmax between 20 W and 2000 W, when tested at standard test conditions (STC) corresponding to incident solar irradiance of 1000 W/m2, module temperature of 25 degrees C., and air mass 1.5 (AM1.5) solar spectrum. Some modules used in PV power plants may have ratings outside these ranges at STC, and/or may operate outside these ranges at conditions other than STC, such as higher or lower irradiance, higher or lower temperature, coverage with dust or other contaminants (“soiling”), or other variations in conditions.

Measuring the I-V characteristics (equivalently “I-V data”) of a PV module installed in a PV power plant can provide useful information relevant to assessing or monitoring performance of the PV power plant. Some parameters of interest for measurement in a solar power plant which may benefit from PV module I-V characteristics measurement include solar irradiance; effective solar irradiance usable by PV modules, including front-side, rear-side, and total irradiance in the case of bifacial PV modules; PV module power output capability; structural shading and electrical mismatch factors that limit PV module power output capability according to shading and/or non-uniformity of irradiance reaching PV modules; power losses due to soiling, the accumulation of dust and dirt on PV modules; bifacial gain, the relative performance of a bifacial module as compared with a monofacial module; degradation, the long-term loss in output power, usually monitored at a consistent reference condition or normalized to a specific reference condition; and others.

In one respect, disclosed is a device configured to measure I-V data of an associated photovoltaic (PV) module coupled to said device.

In another respect, disclosed is a device configured to measure I-V data of an associated PV module coupled to said device and connected to a PV array. Advantageously, according to the disclosed subject matter I-V data may be measured on a PV module device under test that remains connected to the PV array, with only minimal disruption to the power and energy output of the PV module and minimal or negligible disruption to the operation of the array and any connected power utilization or conversion equipment. We designate such measurement as “in-situ” or, equivalently “in-line”.

In another respect, disclosed is a device configured to measure I-V data of a first associated PV module coupled to said device, to receive data from an external device, and to determine a relative performance metric based at least upon measuring said I-V data of said first associated PV module and said data from said external device. In one embodiment, said data from said external device comprises I-V data of a second associated PV module coupled to said external device.

In another respect, disclosed is a system comprising a first device configured to measure I-V data of a first associated PV module, and a second device configured to measure I-V data of a second associated PV module, wherein said first device is configured to send said I-V data of said first associated PV module to said second device, and wherein said second device is configured to determine a relative performance metric based at least upon said I-V data of said first associated PV module and said I-V data of said second associated PV module.

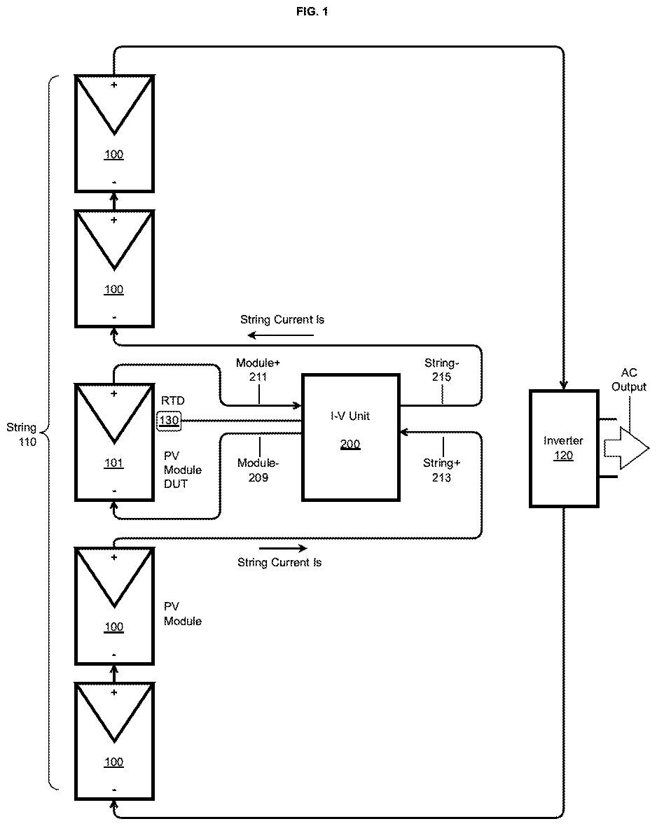

FIG. 1 depicts an exemplary string (110) of PV modules (100, 101) which provide power to a PV array and thereby to inverter (120) which produces AC power output. The PV array may comprise multiple strings (110) which may be comprised of varying numbers of PV modules (100, 101) arranged in series and/or parallel combinations. One of the modules (101) of string (110) is a PV module device under test (DUT) (101) whose I-V characteristics are to be measured by I-V measurement unit (200). The positive and negative outputs of PV module DUT (101) are electrically connected to I-V unit (200) via connections (211) and (209), which may comprise cables, terminals, or other means. The outputs of I-V unit (200) are electrically connected to modules (100) of string (110) via connections (213) and (215), while may comprise cables, terminals, or other means. Arrows in FIG. 1 indicate the direction of current flow. PV module DUT (101) is in series with PV modules (100) of string (110) via its connection to I-V unit (200). In one mode of operation, positive string current (Is) flows through connection (213) into I-V unit (200), then into PV module DUT (101) via connection (209), then from PV module DUT (101) to I-V unit (200) via connection (211), and then into the remainder of string (110) via connection (215).

Besides the exemplary arrangement depicted in FIG. 1, other numbers of modules (100), PV module DUTs (101), strings (110), and inverters (120), including series and parallel combinations thereof, and types of power utilization equipment such as loads and storage systems or series and parallel combinations thereof, could be used and be within the scope of this disclosure.

I-V unit (200) may be configured in various operation modes, including a pass-through mode in which PV module DUT (101) is directly connected in series within string (110) with minimal loss of power, and a measurement mode in which I-V characteristics of PV module DUT (101) are measured. I-V unit (200) may be configured to periodically change between a pass-through mode and a measurement mode.

In a pass-through mode of operation, DUT (101) is in series with string (110), and, normally, the current flowing through string (110), denoted the string current Is, will also be flowing through DUT (101); positive string current (Is) flows via connections (213), (209), (211), (215) in sequence as indicated by the direction of arrows. DUT (101) will then operate at a current and voltage operating point where the current is defined by the string current Is and the corresponding voltage is determined by the I-V curve of DUT (101). The direction of current flow is exemplary and could be defined or arranged differently.

In a measurement mode of operation, I-V unit (200) causes the operating point of DUT (101) to shift to higher or lower current (equivalently, lower or higher voltage) while I-V unit (200) measures at least a portion of the DUT (101) I-V curve.

In one embodiment temperature sensor (130), which may comprise a resistive temperature detector (RTD) or other sensor type, is used by I-V unit (200) to measure a temperature of DUT (101). Said temperature may be used to calibrate or adjust I-V characteristics measured by I-V unit (200) or other values calculated therefrom. In another embodiment, I-V unit (200) determines the temperature of DUT (101) from its I-V characteristics, for example by using measurements of DUT (101) open-circuit voltage and short-circuit current.

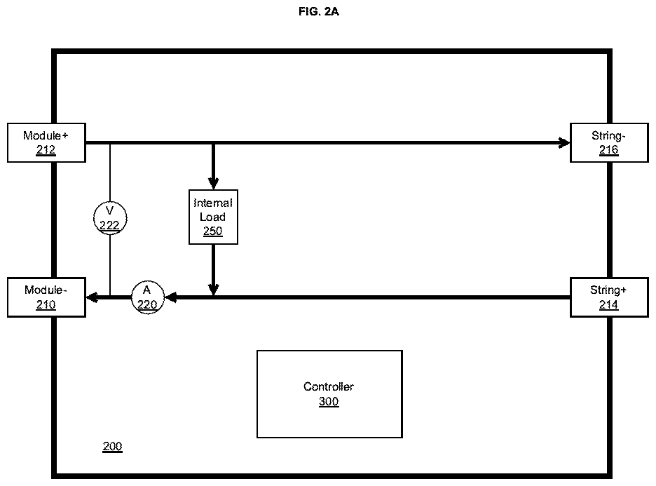

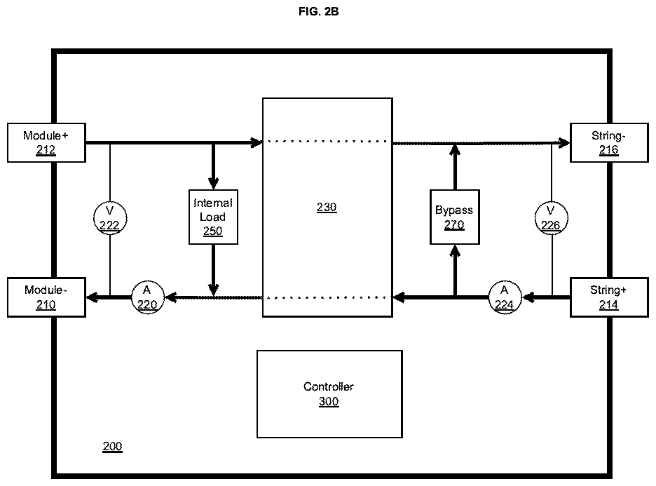

FIG. 2A depicts some main elements of an embodiment of I-V unit (200) according to the present disclosure. Module− (210), module+ (212), string+ (214), string-(216) connections (or terminals) serve the purposes discussed in connection to FIG. 1 by coupling to connections (209), (211), (213), and (215), respectively. Current measurement circuit (220) measures the current flowing through PV module DUT (101). Voltage measurement circuit (222) measures the output voltage of PV module DUT (101) applied as input to I-V unit (200). In one embodiment, variable load (250) draws a variable, programmable current from module DUT (101), which, in one embodiment, is controlled by controller (300). Controller (300) controls I-V unit (200), performs measurements, and communicates data. Controller (300) comprises at least one processor, which may comprise, for example, a microcontroller, microprocessor, floating point gate array (FPGA), computer, or similar device. The functions of controller (300) may also be spread over multiple such devices. Controller (300) may also comprise one or more memory units, including non-volatile memory and volatile memory.

In one embodiment, variable load (250) comprises a programmable electronic load, which may be implemented using transistors and a feedback circuit designed to control the transistors to achieve a targeted condition, such as a targeted current, voltage, resistance, or power of the variable load (250). In an exemplary embodiment, MOSFET transistors are used with a feedback circuit that controls the MOSFET gate voltages to achieve a targeted current through variable load (250). Variable load (250) dissipates power according to the product of the current through variable load (250) and the voltage across variable load (250). The DUT (101) module supplies power dissipated by variable load (250) and variable load (250) functions to shift the operating point of DUT (101) by drawing current (equivalently, power) from DUT (101). In some embodiments, the DUT (101) module provides current/power simultaneously to variable load (250) and to string (110) (via string connections 214, 216), thereby ultimately to inverter (120) (or any other load in place of inverter (120)) which is supplied by string (110). In some embodiments the current flowing through DUT (101) module comprises a combination of a string current Is and the current flowing through variable load (250), thus providing that drawing a current through variable load (250) shifts the current-voltage (I-V) operating point of DUT (101). Advantageously, in some embodiments this provides that the operating point of DUT (101) is shifted without disconnecting DUT (101) from the string (110) and without dissipating the entire DUT (101) module current in the variable load (250). For example, in an exemplary embodiment, string current Is flowing into terminal (214) is 9 A, and internal load (250) is programmed to draw 1 A, such that current flowing in and out of DUT (101) via terminals (210) and (212) is 10 A while string current Is flowing in and out of terminals (214) and (216) is only 9 A.

In other embodiments, variable load (250) comprises alternate components, such as any other type of transistor, variable resistor, or variable resistance device, with or without a feedback circuit.

In some embodiments, variable load (250) draws from DUT (101) module a current ranging from 0-100% of DUT (101) Isc or a power ranging from 0-100% of DUT (101) Pmax when variable load (250) is in operation. In some embodiments, variable load (250) draws from DUT (101) a current ranging from 0-10% of DUT (101) Isc or a power ranging from 0-10% of DUT (101) Pmax when variable load (250) is in operation.

In the embodiment depicted in FIG. 2A, connections (212) and (216) are electrically equivalent. Therefore, in this embodiment depicted in FIG. 2A, while four terminals (210, 212, 214, 216) are shown, the embodiment could be implemented equivalently with three terminals (210, 212, 214). In this case connections (215) and (211) depicted in FIG. 1 may be connected directly together outside of I-V unit (200), for example using a Y-cable to connect I-V unit (200), DUT (101), and remainder of string (100). In some embodiments current meter (220) is moved and placed in series between terminals (212) and (216), such that terminals (210) and (214) are equivalent instead of (212) and (216), and I-V unit requires only terminals (210, 212, 216).

FIG. 2B depicts main elements of another embodiment of I-V unit (200) according to the present disclosure. Module− (210), module+ (212), string+ (214), string-(216) connections (or terminals) serve the purposes discussed in connection to FIG. 1 and FIG. 2A, by coupling to connections (209), (211), (213), and (215), respectively. Current measurement circuit (220) measures the current flowing through PV module DUT (101). Voltage measurement circuit (222) measures the output voltage of PV module DUT (101) applied as input to I-V unit (200). In one embodiment, variable load (250) draws a variable, programmable current from module DUT (101) controlled by controller (300). In one embodiment, coupling circuit (230) transfers power from PV module DUT (101) to the output via string+ (214) and string− (216) connections. Optionally, current (224) and voltage (226) measurement circuits measure current and/or voltage at the output. Optionally, bypass (270) permits current flowing in string (110) via string+ (214) and string− (216) to bypass coupling circuit (230), preventing interruption of current flowing in string (110). Controller (300) controls I-V unit (200), performs measurements, and communicates data. Controller (300) comprises at least one processor, which may comprise, for example, a microcontroller, microprocessor, floating point gate array (FPGA), computer, or similar device. The functions of controller (300) may also be spread over multiple such devices. Controller (300) may also comprise one or more memory units, including non-volatile memory and volatile memory.

The potential of string− (216) is normally more positive than the potential of string+ (214); polarity designations indicate the polarity of cables from modules (100) of string (110) which are to be connected, not the polarity of relative voltage between (214) and (216). Arrows indicate the normal direction of positive current flow.

Coupling circuit (230) transfers power from PV module DUT (101) to the output via string+ (214) and string− (216) connections. Current flows from (214) to (210) via coupling circuit (230), as indicated by a dotted line, and from (212) to (216) via (230), as indicated by a separate dotted line.

In one embodiment, coupling circuit (230) comprises direct connections between (212) and (216) and between (210) and (214), as in FIG. 2A.

In another embodiment of coupling circuit (230), the connection between (212) and (216), and/or between (210) and (214), is interrupted by a switch, such as a transistor or other switching device.

In another embodiment, coupling circuit (230) comprises a DC-DC switching power converter, comprising transistors, inductors, diodes, and capacitors, and organized, for example, as a buck converter, boost converter, buck-boost converter, or other related or similar topology for DC-DC power conversion, wherein conversion from one DC current/voltage combination to another is achieved by repetitive switching, typically at frequencies ranging from 50 kHz to 1000 kHz, and adjustment of duty cycles of switching in order to achieve a targeted condition. In some configurations, coupling circuit (230) may operate in a switched mode, as discussed. In some configurations, coupling circuit (230) may be configured in a pass-through mode. In some configurations, coupling circuit (230) may comprise one or more switches that connect or disconnect module + and/or − (212, 210) from string− and/or + (216, 214).

In one embodiment, I-V unit (200) performs measurement of at least a portion of an I-V curve by following the steps of changing the state of variable load (250) and/or changing the state of coupling circuit (230) to change the current and voltage of PV module DUT (101), measuring PV module DUT (101) current and voltage via measurement circuits (220) and (222), and repeating this process to acquire at least a portion of an I-V curve. In one embodiment, during this process PV module DUT (101) continues to provide power to outputs (214, 216) via coupling circuit (230), although potentially with reduced efficiency and/or reduced power delivery during the measurement process.

In one embodiment, I-V unit (200) alternates between a pass-through operation mode and a measurement operation mode. In a pass-through operation mode variable load (250) is configured to draw substantially zero current (i.e. <1-5% of DUT (101) short-circuit current) and coupling circuit (230) is configured to directly connect module DUT (101) via connections (210, 212) to the outputs (214, 216). In a measurement operation mode coupling circuit (230) and/or variable load (250) are used to alter the current and voltage state of DUT (101) to measure an I-V curve. (In the foregoing, “direct connection” does not preclude intervening measurement circuits (220, 222, 224, 226) or other components or functional blocks which minimally disturb the transfer of power from PV module DUT (101) to the output of I-V unit (200).)

In one embodiment, the measured I-V curve is a full I-V curve ranging from short-circuit to open-circuit or vice versa. In one embodiment, the I-V curve is measured in one sequence, while in other embodiments it is measured in one or more portions. In one embodiment, the measured I-V curve is a mini I-V curve concentrated on one or more portions of the I-V curve near maximum power, short-circuit, open-circuit or other point or points of interest within the full I-V curve. In one embodiment, measurement is performed while limiting the maximum loss of power output during the measurement to within a substantially small threshold such as 10%, or other substantially small value; for example, this may be achieved when measuring a portion of the I-V curve near maximum power point by ensuring that current and voltage are maintained at points where power output is within 10% of the maximum power.

In one embodiment, I-V unit (200) operates in a pass-through mode most of the time, switching to a measurement mode for a short time, for example once per minute. In an exemplary embodiment, a full I-V curve takes approximately 500 milliseconds once per minute and a mini I-V curve takes approximately 200 milliseconds once every 1-10 seconds.

In one embodiment controller (300) determines fit parameters from the measured I-V curve, such as short-circuit current, open-circuit voltage, maximum power, voltage at maximum power, or current at maximum power. The parameters that may be determined may depend on which portion of an I-V curve is measured. In one embodiment, fit values and/or I-V curves, or values calculated therefrom, are adjusted or calibrated by the temperature of PV module DUT (101) measured by sensor (130) or other means, as discussed. In some embodiments, controller (300) determines parameters derived from the measured I-V curve, such as measures of PV module series or shunt resistance or parameters derived from the measured I-V curve together with calibration values for DUT (101), such as measures of effective irradiance or temperature.

In some embodiments depicted by FIG. 2B, coupling circuit (230) directly connects (214) to (210) and (212) to (216), in which case only three terminals from among the group (210, 212, 214, 216) are required, as discussed in connection with FIG. 2A.

In some embodiments, current measurement circuit (220) is placed in series between (212) and (230), and/or optional current measurement circuit (224) is placed in series between (216) and (230).

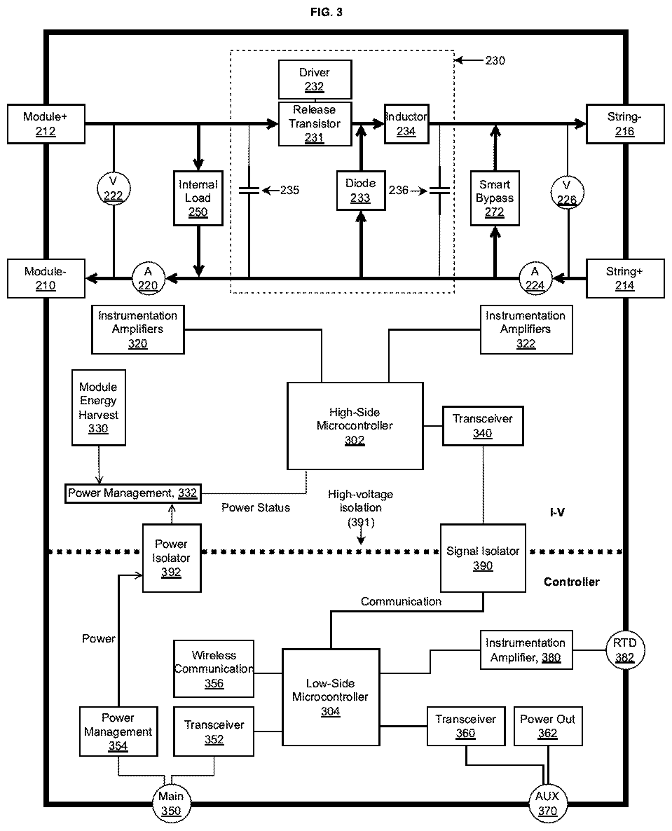

FIG. 3 depicts detailed components of an embodiment of an I-V unit (200) similar to embodiments depicted in FIG. 2B.

One embodiment of coupling circuit (230) is depicted in FIG. 3. The depicted embodiment has a topology similar to a buck converter, a DC-DC step-down switching power converter in which the output voltage (the voltage that would be measured at 226) is always less than or equal to the input voltage (the voltage that would be measured at 222). A release transistor (231), such as a MOSFET, is operated via driver (232) (which, for example, sets a gate voltage of release transistor (231)) at a high frequency, such as 10-200 kHz in an exemplary embodiment, at a variable duty cycle ranging from 0% to 100%, wherein 0% corresponds to a fully open/non-conducting state of release transistor (231) and 100% corresponds to a fully closed/connected state of release transistor (231). Diode (233), inductor (234), capacitor (235), and capacitor (236) perform the typical functions of these components in a buck converter topology. With duty cycle of release transistor (231) equal to 100%, output voltage between string− (216) and string+ (214) is substantially equal to input voltage between module+ (212) and module− (210). As duty cycle is reduced, the time averaged module input voltage (between 212 and 210) increases and the time averaged output voltage (between 216 and 214) decreases. However, string (110) current flowing through I-V unit (200) via connections (214, 216) is not changed; during portions of the duty cycle of (231) when (231) is non-conducting, current flows through diode (233). In some embodiments, a hardware or software feedback loop is used to adjust duty cycle of release transistor (231) to maintain a desired condition; in some embodiments, there is no feedback loop, and controller (300) directly determines the duty cycle of release transistor (231).

Any of the components may be duplicated or paralleled to increase power dissipation capability. Component positions may be interchanged in ways that achieve the same or similar function.

In one embodiment, as depicted in FIG. 3, controller (300) functions are divided between a high-side controller (302), dedicated to controlling the I-V measurement circuitry, and a low-side controller (304), which provides user communication, data storage, calculations, control, communication to networked devices, etc. High-side controller (302) and/or low-side controller (304) may comprise one or more processors, such as microprocessors, microcontrollers, FPGA's, or similar devices, coupled to one or more memory units including volatile and/or non-volatile memory, and/or computers or similar devices.

In one embodiment, as depicted in FIG. 3, the device is divided into isolated zones, a high side and low side, isolated by up to 1500 VDC (or more) through voltage isolation (391) comprising adequate creepage and clearance and bridged where needed by power isolator (392) and/or signal isolator (390). This is to protect an operator or other devices connected to I-V unit (200) from high voltages that may be present on string (110).

In one embodiment driver (232) is controlled by high-side microcontroller (302) according to an algorithm for a full sweep (full I-V curve) or a mini sweep (mini I-V curve).

In one embodiment the mini sweep is limited to points within 10% of the maximum power point of PV module DUT (101), or other substantially small threshold. In one embodiment mini sweep ranges from points with voltage substantially below the maximum power point voltage, for example at least 5% below, to points with voltage substantially above the maximum power point voltage, for example at least 5% above.

In one embodiment the mini sweep is limited to one or more points substantially near short-circuit, for example points with current within 1% of short-circuit current and/or with voltage less than 5% of open-circuit voltage.

In one embodiment the mini sweep is limited to one or more points substantially near open-circuit, for example points with voltage within 5% of open-circuit voltage and/or with current less than 5% of short-circuit current.

Other functions of high-side microcontroller (302) include performing measurements via measurement circuits (220, 222, 224, 226) and associated instrumentation amplifiers (320, 322) and other measurement circuits and communicating with low-side microcontroller (304) via transceiver (340) and signal isolator (390).

Division of functions between high-side microcontroller (302) and low-side microcontroller (304) is exemplary. Functions could be apportioned differently or combined.

Detailed components and functional blocks depicted in FIG. 3 are exemplary. In some embodiments various components are omitted, interchanged, re-organized, or substituted with other components or functional blocks providing equivalent function. For example, in some embodiments measurement circuits (224) and (226) are omitted.

Power is provided to the exemplary device via main power and communication connection (350), which supplies power management circuitry (354) and transceiver (352). Optionally, wireless communication (356) is provided. Power is provided from the low side to the high side via power isolator (392). In one embodiment instrumentation amplifier (380) measures temperature sensor (130) via connection (382), depicted as a connection for an RTD (130). In one embodiment output power is provided via power out (362) to an auxiliary connection (370), together with communication signals via transceiver (360) from low-side microcontroller (304).

In one embodiment, separation into high-side and low-side zones is omitted. In one embodiment, external power and/or communication connections (350) and (370) are omitted, and communication is performed wirelessly or over module and/or string cabling.

In some embodiments auxiliary connection (370) is used to enable and communicate with external (networked) devices which may be used to calibrate or adjust measured I-V characteristics and/or values calculated therefrom. In some embodiments, external (networked) devices include another I-V unit (200) measuring another PV module DUT (101), a PV reference cell measuring solar irradiance or effective irradiance, and/or a soiling measurement device, such as an optical soiling measurement device, measuring a soiling loss. In some embodiments, the foregoing external (networked) devices communicate via the main power and communication port (350) rather than through auxiliary connection (port) (370). In some embodiments auxiliary connection (port) (370) is omitted.

In one embodiment, when external power via (350) is unavailable, the I-V unit (200) defaults to a pass-through mode of operation in which release transistor (231) is continuously conducting. In one embodiment, power to maintain the gate control of release transistor (231) at the voltage required for conduction is derived from PV module DUT (101) via module energy harvest (power generation) circuit (330) which feeds power management circuit (332) which selects (or combines and/or monitors) either externally available power supplied by the user via (350) or module (101) power. This provides that module (101) current/voltage is passed through even if external power via (350) is missing. In some embodiments module-derived (energy harvest) power via (330) also offsets the power requirements of the I-V unit (200) by reducing power demand via the main connection (350) and/or offsets power required to be transferred internally within I-V unit (200) from a low-side zone to a high-side zone.

Diode (233) serves the function of bypass (270). In the event that release transistor (231) remains in a non-conducting state for an extended period, diode (233) may encounter significant power dissipation, due to the product of conducted current and diode (233) voltage drop. In one embodiment smart bypass (272), in parallel with diode (233) provides an alternate or supplementary bypass function which reduces power dissipation and therefore reduces heat load. In one embodiment smart bypass (272) comprises a smart bypass energy harvester which derives a small amount of power from the voltage across diode (233) and uses this power to enable the gates of one or more transistors in parallel with (272) in FIG. 3, thus conducting current with low voltage drop and therefore low power dissipation. In one embodiment, smart bypass (272) operates continuously when required. In one embodiment smart bypass (272) operates in a hiccup fashion: the smart bypass energy harvester derives power from the voltage drop across (233), this power puts transistors into conduction which lowers the voltage drop for a time, the derived power is exhausted, the transistors go into open/non-conducting state again, current flows through the diode (233) again, and the cycle repeats. The time average power dissipated by diode (233) is reduced. In one embodiment smart bypass (272) is automatically disengaged whenever voltage between string− (216) and string+ (214) exceeds a threshold, indicating bypass is no longer needed. In one embodiment smart bypass (272) is disabled by a signal from high-side microcontroller (302), for example during an I-V sweep.

I-V sweeps are performed as discussed above in connection with FIG. 2B, using variable load (250) and/or coupling circuit (230).

In one embodiment, variable load (250) provides for increasing the current flowing from DUT (101) so that it is larger than the string current Is flowing in string (110). In one embodiment, the full current flowing in DUT (101) is substantially equal to the string current Is plus the current drawn by variable load (250), or is otherwise comprised of a combination of the string current Is and the variable load (250) current. Advantageously, this allows that DUT (101) may be shifted to a high-current point on its I-V curve while the majority of the module's current is flowing out to string (110) (and thereby to inverter (120) or any other load in place of inverter (120)) and only a small part is dissipated in variable load (250). For example, in an exemplary embodiment, string current Is flowing into terminal (214) is 9 A, and internal load (250) is programmed to draw 1 A, such that current flowing in and out of DUT (101) via terminals (210) and (212) is 10 A while string current Is flowing in and out of terminals (214) and (216) is only 9 A.

In one embodiment, as depicted in FIG. 3, coupling circuit (230) is implemented similar to a buck converter, and has the capability to decrease the current drawn from module DUT (101), by reducing the duty cycle of release transistor (231). In one embodiment, the opposite function, increasing the current drawn from module DUT (101) is provided by variable load (250). Thus, in the embodiment depicted in FIG. 3, variable load (250) provides for increasing the current in DUT (101) while coupling circuit (230), as depicted in the figure, provides for reducing the current in DUT (101), and shifts in either direction are accomplished without interrupting string current flowing in string (110), without disconnecting DUT (101), and with only minimal reduction in the amount of power delivered by DUT (101) to the outputs.

In other embodiments, measurement circuits (220, 222, 224, and/or 226) are placed in alternate positions in the circuit while serving the same or similar functions. For example, current measurement circuits (220 and/or 224) could be placed on the high-side leg of the circuit instead of the low-side leg as shown in FIG. 3, or voltage measurement circuits (222, and/or 226) could be placed in other circuit locations to measure essentially the same or similar voltages.

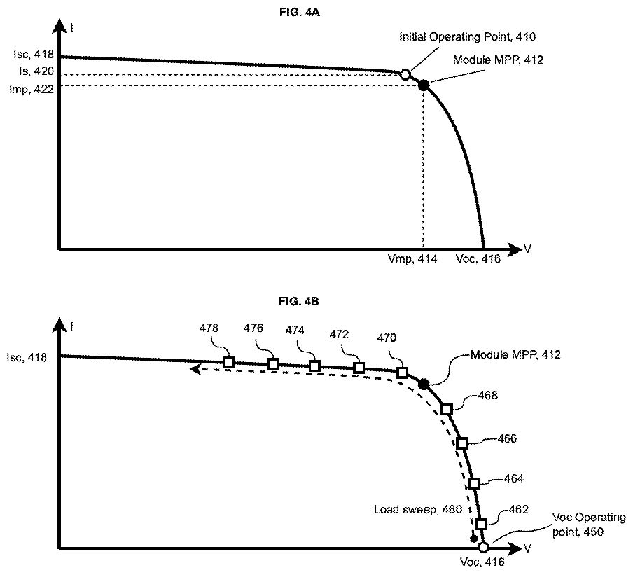

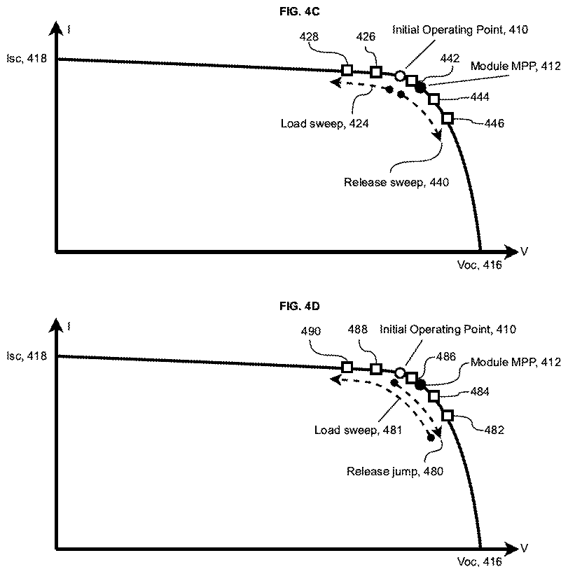

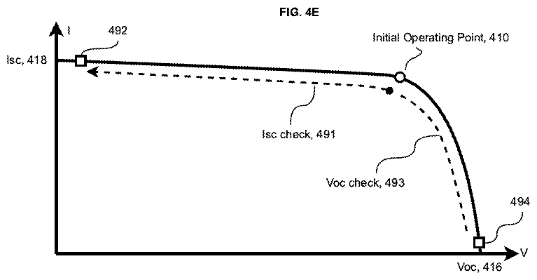

FIG. 4A depicts an exemplary I-V curve of a photovoltaic module DUT (101) operating within a string (110). Key points on the I-V curve include the short-circuit current Isc (418), the open circuit voltage Voc (416), the maximum power point MPP (412), the maximum power point voltage Vmp (414), and the maximum power point current Imp (422). In this example we consider the case where the string current Is (420) is greater than Imp (422) of PV module DUT (101). Since PV module DUT (101) is in series with the string, it must operate at substantially the same current Is (420), causing PV module DUT (101) to operate at the initial operating point (410) depicted in FIG. 4A. Although inverter (120) normally functions to keep the PV array at its collective maximum power point, initial operating point (410) is not necessarily the maximum power point MPP (412) of DUT (101), because all modules (100, 101) in the PV array may have slightly different maximum power points and because inverter (120) may at times operate the PV array at conditions other than its maximum power condition, including conditions of less than maximum power or even conditions in which inverter (120) is off (or not present at all) such that string current Is may in some cases or embodiments be 0. Therefore, to determine the MPP (412) value of DUT (101) an I-V sweep is required.

FIG. 4B depicts a full sweep of an I-V curve in FIG. 4A using an embodiment of an I-V unit (200) depicted in FIG. 3. Initially, the device of FIG. 3 operates in a pass-through mode, wherein duty cycle of release transistor (231) is 100% and variable load (250) current is 0, such that PV module DUT (101) is directly connected to the output connections (214, 216) with no interference. PV module DUT (101) thus operates at initial operating point (410), set by string current Is (420), as depicted in FIG. 4A. For a full sweep, in one embodiment, release transistor (231) duty cycle is set to 0%, causing PV module DUT (101) to go to open circuit, the Voc operating point (450) depicted in FIG. 4B. Load current of variable load (250) is now progressively increased executing load sweep (460) wherein PV module DUT (101) operating point is progressively moved towards short circuit through exemplary operating points (462, 464, 466, 468, 470, 472, 474, 476, 478). In one embodiment, a short delay is introduced at each operating point, which may facilitate settling of measurement circuitry and/or may prevent excessive sweep rates which can lead to inaccurate I-V curve results due to DUT (101) properties such as internal capacitance and related effects. In one embodiment, module current and/or voltage measurement circuits (220, 222) measure current and/or voltage at each operating point, collecting data of the I-V curve. In one embodiment, data are subsequently fit to determine parameters of the I-V curve, such as current Imp (422), voltage Vmp (414), and/or power of MPP (412) (Imp times Vmp), short-circuit current (418), open-circuit voltage (416), and/or other parameters. In one embodiment, the full I-V sweep covers substantially the entire I-V curve, ranging from near open circuit (e.g. currents less than approximately 5% of Isc) to near short circuit (e.g. voltages less than approximately 5% of Voc). A small number of operating points (462, 464, 466, 468, 470, 472, 474, 476, 478) are depicted for clarity, but any number could be used. In one embodiment, the full I-V sweep is completed in approximately 500 milliseconds. In one embodiment, when I-V sweep has been completed, release transistor (231) duty cycle and variable load (250) current are returned to their default conditions of 100% and 0, respectively, such that PV module DUT (101) returns to being directly connected to output connections (214, 216) with no interference.

In some embodiments, additional or alternative steps are used in collection of a full I-V sweep. In one embodiment, in an additional step, variable load (250) current is initially set to a maximum value, PV module DUT (101) short-circuit current (418) is determined, and short-circuit current value is then used to determine a step size for progressing between operating points (462, 464, 466, 468, 470, 472, 474, 476, 478); in some embodiments the step size may be variable and chosen to optimize the distribution of points along the curve, for example to make points evenly spaced in current, evenly spaced in voltage, evenly spaced along the length of the curve itself, more densely spaced around the MPP, and/or other optimizations. In some embodiments, the sequence progresses from open circuit towards short circuit, while in other embodiments the sequence progresses from short circuit towards open circuit. In some embodiments, the sequence is composed of multiple sub-sequences capturing different portions of the I-V curve. In some cases or embodiments, DUT (101) conditions may change during the measurement (for example, if solar irradiance changes) and therefore the final operating point after the measurement sequence may differ from initial operating point (410).

FIG. 4C depicts a mini sweep near the MPP of an I-V curve in FIG. 4A using an embodiment of an I-V unit (200) depicted in FIG. 3. Initially, the device of FIG. 3 operates in a pass-through mode, wherein duty cycle of release transistor (231) is 100% and variable load (250) current is 0, such that PV module DUT (101) is directly connected to the output connections (214, 216) with no interference, and DUT (101) operates at initial operating point (410) where current equals string current Is (420). In one embodiment, release transistor (231) duty cycle is then progressively decreased, executing release sweep (440) in which PV module DUT (101) operating point is progressively moved towards open circuit through exemplary operating points (442, 444, 446). Subsequently in one embodiment release transistor (231) duty cycle is returned to 100% and variable load (250) current is progressively increased executing load sweep (424) such that operating point is progressively moved toward short circuit through operating points (426, 428). In one embodiment release transistor (231) duty cycle and variable load (250) current are then returned to default conditions of 100% and 0, respectively, returning PV module DUT (101) to direct connection to output connections (214, 216) with no interference. Measurements points collected during release sweep (440) and/or load sweep (424) may be combined to form the mini I-V sweep. In one embodiment, a short delay is introduced at each operating point. In one embodiment, module current and/or voltage measurement circuits (220, 222) measure current and/or voltage at each operating point, collecting data of the mini I-V sweep. In one embodiment, release sweep (440) and/or load sweep (424) stop when measured power of PV module DUT (101), the product of current and voltage measured by current and voltage measurement circuits (220, 222), reaches a threshold, such as 10% below the power measured at initial operating point (410) or 10% below the maximum power measured during release sweep (440) and/or load sweep (424). In one embodiment, following collection of mini I-V sweep, data are subsequently fit to determine parameters of the I-V curve, such as current Imp (422) and voltage Vmp (414) of MPP (412). A small number of exemplary operating points (442, 444, 446, 426, 428) of release sweep (440) and load sweep (424) are depicted for clarity, but any number could be used. In one embodiment, mini I-V sweep near MPP is completed in approximately 100-200 milliseconds. In some embodiments, release sweep (440) and load sweep (424) are performed in the opposite order. In one embodiment, when the mini I-V sweep has been completed, release transistor (231) duty cycle and variable load (250) current are returned to their default conditions of 100% and 0, respectively, such that PV module DUT (101) returns to being directly connected to output connections (214, 216) with no interference. In some cases or embodiments, DUT (101) conditions may change during the measurement (for example, if solar irradiance changes) and therefore the final operating point after the measurement sequence may differ from initial operating point (410).

FIG. 4D depicts another embodiment of a mini sweep near the MPP of an I-V curve in FIG. 4A using an embodiment of an I-V unit (200) depicted in FIG. 3. Initially, the device of FIG. 3 operates in a pass-through mode, wherein duty cycle of release transistor (231) is 100% and variable load (250) current is 0, such that PV module DUT (101) is directly connected to the output connections (214, 216) with no interference, and DUT (101) operates at initial operating point (410). In one embodiment, release transistor (231) duty cycle is then decreased to a fixed value less than 100%, executing release jump (480) in which PV module DUT (101) operating point is moved in a large step towards open circuit to exemplary operating point (482). Subsequently, in one embodiment, release transistor (231) duty cycle is maintained at the fixed value while variable load (250) current is progressively increased executing load sweep (481) such that the DUT (101) operating point is progressively moved toward short circuit through operating points (482, 484, 486, 488, 490). In one embodiment release transistor (231) duty cycle and variable load (250) current are then returned to default conditions of 100% and 0, respectively, returning PV module DUT (101) to direct connection to output connections (214, 216) with no interference. In one embodiment, a short delay is introduced at each operating point. In one embodiment, module current and/or voltage measurement circuits (220, 222) measure current and/or voltage at each operating point, collecting data of the mini I-V curve. In one embodiment, release jump (480) and/or load sweep (481) are configured such that the power output of DUT (101) is maintained within 10% of its maximum power or the power of initial operating point (410). In one embodiment, load sweep (481) proceeds in the opposite direction, from higher current to lower current. In one embodiment, following collection of the mini I-V sweep, data are subsequently fit to determine parameters of the I-V curve, such as current and voltage of MPP (412). A small number of exemplary operating points (482, 484, 486, 488, 490) are depicted for clarity, but any number could be used. In one embodiment, the mini I-V sweep is completed in approximately 100-200 milliseconds.

FIG. 4E depicts an embodiment of a mini sweep near the short-circuit and open-circuit conditions of the I-V curve in FIG. 4A using an embodiment of an I-V unit (200) depicted in FIG. 3. Initially, the device of FIG. 3 operates in a pass-through mode, wherein duty cycle of release transistor (231) is 100% and variable load (250) current is 0, such that PV module DUT (101) is directly connected to the output connections (214, 216) with no interference, and DUT (101) operates at initial operating point (410). In one embodiment, variable load (250) is programmed to its maximum load current, executing Isc check (491) and moving DUT (101) operating point to (492), which is substantially near short circuit (e.g. voltage less than 5% of Voc); in one embodiment multiple points near (492) are visited. Subsequently variable load (250) is programmed to 0 current and release transistor (231) duty cycle is set to 0, executing Voc check (493) and moving DUT (101) operating point to (494), which is substantially near open circuit (e.g. current less than 5% of Isc); in one embodiment multiple points near (494) are visited. In one embodiment, module current and/or voltage measurement circuits (220, 222) measure current and/or voltage at operating points (492, 494) and/or neighboring points. In one embodiment, from these data Isc (418) and/or Voc (416) values are determined. In one embodiment Isc check (491) and Voc check (493) are performed in the opposite order and in other embodiments one of them is omitted. In one embodiment the mini sweep near the short-circuit and/or open-circuit conditions (“Isc/Voc”) is completed in approximately 40-100 milliseconds.

Advantageously, embodiments similar to that depicted in FIG. 3 executing sequences depicted in FIG. 4C, FIG. 4D, and FIG. 4E and other similar sequences incorporating the same or similar steps in different orders and combinations, allows that DUT (101) may be shifted to higher-current points on its I-V curve while DUT (101) remains connected to the output (i.e. without disconnection of DUT (101)), most of the module's current is flowing out to string (110), and only a small part is dissipated in variable load (250). Advantageously, this minimizes disruption to string (110) and inverter (120) (or load or other power utilization system in place of inverter (120)), maximizes efficiency, and minimizes power dissipation on variable load (250), permitting more frequent measurement and/or smaller heat sinks and enclosure corresponding to lower power dissipation.

Advantageously, mini I-V sweeps depicted in FIG. 4C and/or FIG. 4D, and other similar embodiments incorporating the same or similar steps in different orders and combinations, result in minimal disturbance to the remainder of the PV array and to inverter (120), because PV module DUT (101) output power delivered to inverter (120) is reduced from its maximum value by less than a small threshold, for example 10%, and for only a short time. Also, PV module DUT (101) output voltage is reduced from the output voltage at the initial operating point (410) by only a small value, because the mini sweeps remain near MPP; thus any change in string (110) voltage, which might affect maximum power point tracking of inverter (120), is minimized. Thus, mini I-V sweep advantageously determines PV module DUT (101) maximum power with minimal disturbance to inverter (120).

Advantageously, mini I-V sweep depicted in FIG. 4E (“Isc/Voc”) and other similar embodiments incorporating the same or similar steps in different orders and combinations, results in minimal disturbance to inverter (120) because the operation is very fast and therefore may not cause any change in inverter (120) maximum power point tracking.

Although mini I-V sweeps depicted in FIG. 4C and FIG. 4D are configured to include maximum power point MPP (412) in order that MPP (412) current, voltage, and or power may be determined, in other embodiments mini I-V sweeps and/or jumps to specific operating points and conditions, including jumping variable load (250) current and/or release transistor (231) duty cycle to specific values, may be configured to cover other portions of interest of the I-V curve, such as for determining Isc (418) and/or Voc (416) without performing a full I-V sweep. In some embodiments various portions of the I-V curve are measured in various orders in a sequence. In one embodiment, controller (300) adjusts variable load (250) to quickly shift DUT (101) operating point from the initial operating point (410) to Isc, to measure the Isc value without stopping at intervening points. In one embodiment, controller (300) adjusts release transistor (231) duty cycle quickly to 0% to shift DUT (101) operating point from the initial operating point (410) to Voc, to measure the Voc value without stopping at intervening points. In some embodiments such measurements of Isc and/or Voc are performed by themselves while in other embodiments they are performed as part of a sequence with the sequences described in connection to FIG. 4B, FIG. 4C, FIG. 4D, or FIG. 4E. In some embodiments, initial measurement of Isc and/or Voc is used to optimize step sizes for any other part of a sequence. In some embodiments, step sizes are dynamically adjusted to optimize usage of measurement points; for example, current step sizes may be reduced where the slope of the I-V curve is low and increased where its slope is high.

With reference to FIG. 4C and/or FIGS. 4D and/or FIG. 4E, in some embodiments, additional or alternative steps are used in collection of a mini I-V sweep. In various embodiments, load sweep (424) is performed without release sweep (440) or release jump (480), or release sweep (440) or release jump (480) are performed without load sweep (424), or load sweep (424), release sweep (440), and/or release jump (480) are performed in various orders and combinations to measure various portions of the I-V curve in various orders.

In various embodiments, step sizes for load sweep (424) and/or release sweep (440) and/or release jump (480) are based on pre-determined values, are determined from measurements at initial operating point (410) or other operating points along I-V curve or characteristics of the I-V curve, and/or are dynamically determined to optimize I-V measurement with minimum number of measurement points.

In some embodiments release transistor (231) is operated in a simple open or closed fashion, equivalent to duty cycle being 0% or 100%. In some embodiments release transistor (231) is replaced with another kind of switch. In some embodiments, release transistor (231) is omitted and coupling circuit (230) directly connects module connections (210, 212) and string connections (214, 216).

Advantageously, use of variable load (250) allows that the I-V curve of DUT (101) may be measured even when string current Is (420) is 0 and initial operating point (410) is near open-circuit, or equivalently when string (110) is disconnected, not operating, or not present, or when string (110) of modules (100) is not present and DUT (101) is standalone.

FIG. 4A, FIG. 4B, FIG. 4C, FIG. 4D, and FIG. 4E depict an exemplary situation where initial operating point (410), set by string current Is (420), is at a current greater than the maximum power point current Imp (422). However, the embodiments described apply also other situations in which initial operating point (410) is at greater, lesser, or equal current to maximum power point MPP (412) current Imp (422).

In some embodiments, controller (300) uses measurements from current measurement circuits (220, 224) and/or voltage measurement circuits (222, 226) to determine the initial operating point (410) and based on this measurement controller (300) selects a sequence of steps to measure the I-V curve. This selection may comprise choosing one of the sequences depicted in FIG. 4B, FIG. 4C, FIG. 4D, FIG. 4E, or another sequence. For example, if initial operating point (410) corresponds to open-circuit of DUT (101), the sequence depicted in FIG. 4B may be automatically chosen. Or, if initial operating point (410) has current below Imp, release sweep (440) or release jump (480) could be omitted. Or, if initial operating point (410) has current above Imp, load sweep (424, 460, 481) could be omitted.

FIG. 5 depicts schematically the variation in the voltage of a PV module DUT (101) and I-V unit (200) output voltage during an embodiment of release sweep (440) depicted in FIG. 4C. Initially release transistor (231) duty cycle is 100% and PV module DUT (101) operates at initial operating point (410). As release transistor (231) duty cycle is reduced, PV module DUT (101) voltage (500) moves towards open circuit (416) while I-V unit (200) output voltage (510), measured from string+ (214) to string− (216), moves towards 0. Similarly, for the sequence depicted in FIG. 4D, release jump (480) would cause DUT (101) operating point to move abruptly from initial operating point (410) to another operating point at higher module voltage on (500), with corresponding lower output voltage (510).

In some embodiments an I-V unit (200) according to the present disclosure measures only a portion of an I-V curve. For example, as depicted in FIG. 4C and FIG. 4D, only a portion of an I-V curve substantially near MPP (412) is measured, and as depicted in FIG. 4E only portions of an I-V curve substantially near short-circuit and/or open-circuit are measured. In some embodiments, measurements from a portion of an I-V curve may be used by I-V unit (200) via controller (300) to estimate non-measured portions of an I-V curve and/or parameters normally derived therefrom. For example, in one embodiment, after measuring a portion of an I-V curve near MPP (412) as depicted in FIG. 4C and FIG. 4D and subsequently determining Imp (422) and/or Vmp (414), controller (300) may determine corresponding estimated values for Isc (418) and/or Voc (416) using a calculation to account for the estimated relationships between Isc (418) and/or Voc (416) and Imp (422) and/or Vmp (414). Similarly, after measuring a portion of an I-V curve near short circuit and/or open circuit as depicted in FIG. 4E and subsequently determining Isc (418) and/or Voc (416), controller (300) may estimate values for Imp (422) and/or Vmp (414) using a known relationship. Therefore, in some embodiments controller (300) uses estimation to determine estimated parameters from measured parameters.

In some embodiments controller (300) causes I-V unit (200) to perform different kinds of measurements depicted in FIG. 4B, FIG. 4C, FIG. 4D, and/or FIG. 4E in a repeating sequence, and, in some embodiments, uses data obtained in various steps to estimate non-measured results in other steps. For example, in an exemplary embodiment I-V unit (200) performs a full sweep as depicted in FIG. 4B once per 60 seconds, a mini sweep near MPP (412) as depicted in FIG. 4C once per 4-10 seconds, and a mini sweep near short-circuit and open circuit (“Isc/Voc”) as depicted in FIG. 4E once per 1-4 seconds. From the full sweep, an entire I-V curve is obtained and all parameters of the I-V curve (e.g. Isc (418), Voc (416), Imp (422), Vmp (414), maximum power Isc times Voc) are directly determined (“measured”). During the more frequently performed mini sweeps, only subportions of the I-V curve and/or subportions of the corresponding parameters are directly determined from the measurements, but remaining portions of the I-V curve and/or remaining parameters not directly determined from the measurements are estimated. In some embodiments, estimation following the mini sweeps uses values or portions of the I-V curve found for the less frequently performed full sweeps. In some embodiments, this is done by scaling (multiplying) currents and voltages measured during a full sweep by correction factors determined from measurements performed during the mini sweeps, e.g. multiplying full sweep current values times the ratio of an updated value for Isc found during Isc/Voc mini sweep and the previous value for Isc found during the previous full sweep and multiplying full sweep voltages by the ratio of an updated value for Voc found during Isc/Voc mini sweep and the previous value for Voc found during the previous full sweep. In some embodiments, the calculation also corrects for small changes in fill factor (the ratio of Imp*Vmp/(Isc*Voc)) at different irradiance levels, i.e. different values of Isc, or temperatures. Advantageously, this repeated sequence of steps permits vary rapid update of all parameters (for example, once per 1-4 seconds), using estimation from measurements performed less frequently, while minimizing the frequency of performing full sweeps, which generates power dissipation and heat, and while minimizing the fraction of time that a measured DUT (101) is removed from its normal operating condition controlled by the remainder of the string (110) and inverter (120), since mini sweeps are faster than full sweeps. Advantageously, this permits very rapid update of parameters during conditions when irradiance is changing rapidly in cloudy or partly skies or due to motion of modules (100, 101) due to PV array tracker movement.

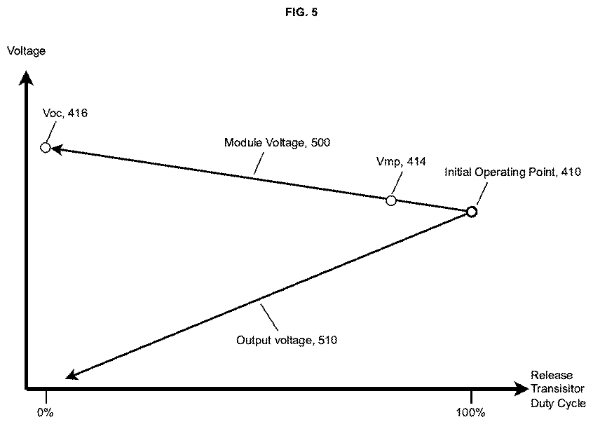

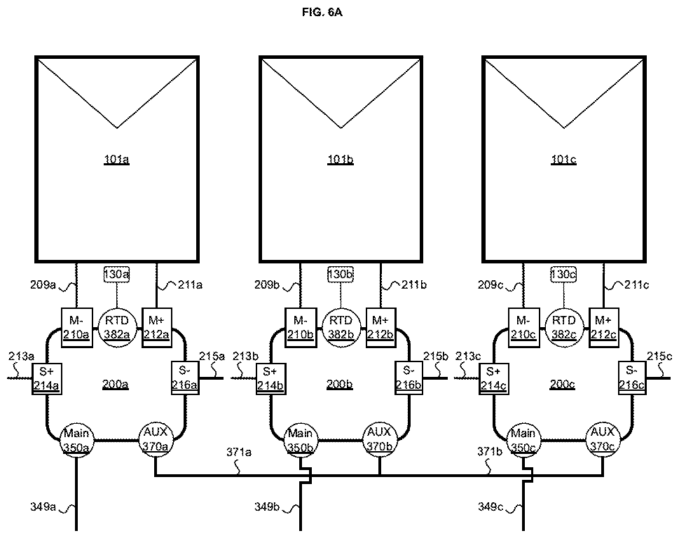

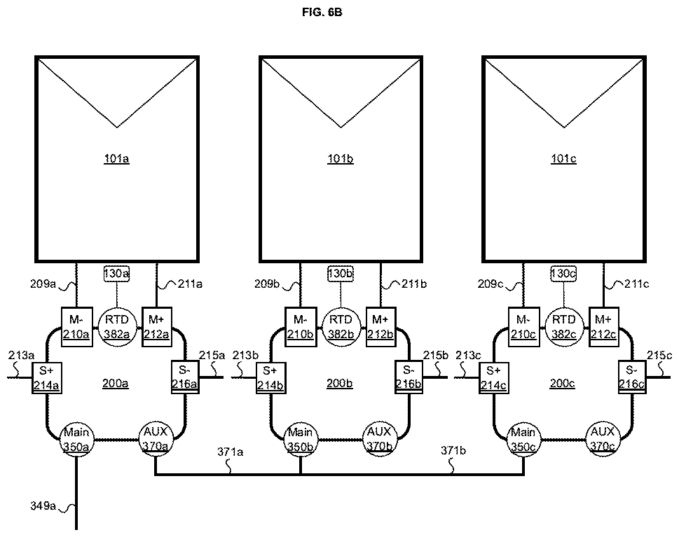

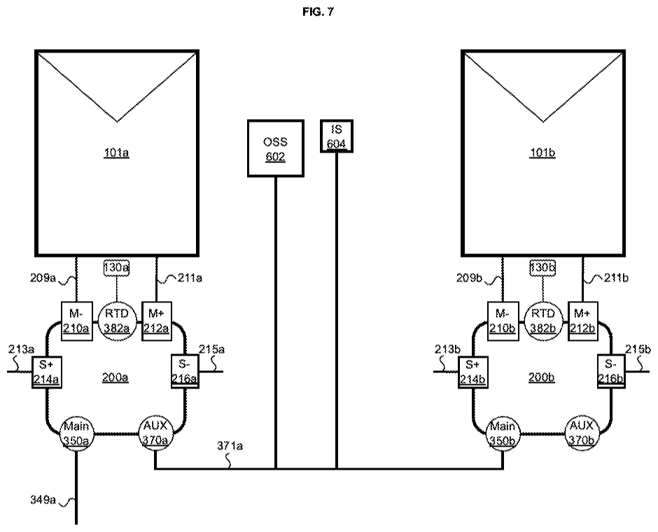

In some embodiments, multiple I-V units (200) may share data to more efficiently implement a particular measurement application that involves comparison of multiple DUTs (101) and/or other instruments, as depicted in FIG. 6A, FIG. 6B, and FIG. 7. In some embodiments data sharing (sending and receiving) permits calculation of a relative performance metric. In some embodiments, communication between I-V units (200) is performed via auxiliary connections (370) and/or main connections (350). In some embodiments when I-V units (200) send or receive data they may adopt particular roles or functions with respect to communication or designation of data. In one embodiment a particular unit is configured to serve as a “leader” and other units are configured to serve as “followers”. The terms “leader” and “follower” indicate relative functions and are exemplary. Other terms could be used, such as “master/slave,” “server/client,” “primary/secondary,” “reference/test,” etc. Any such terms to designate roles and functions for communication for data sharing and for designation of data are within the scope of this disclosure. In some embodiments sending and receiving is organized by a particular I-V unit (200) which initiates communication; in some embodiments sending and receiving can be initiated by any I-V unit (200); in some embodiments sending is generalized by broadcast from a sending I-V unit (200) to all receiving I-V units (200).

In FIG. 6A, FIG. 6B, and FIG. 7 each lettered reference numeral has the same or similar function as its non-lettered counterpart in FIG. 1, FIG. 2A, FIG. 2B, and FIG. 3.

FIG. 6A depicts schematically an embodiment employing multiple I-V units (200a, 200b, 200c) in which a “leader” unit (200a) coordinates data sharing with “follower” units (200b, 200c).

In FIG. 6A, each I-V unit (200a, 200b, 200c) is connected to a DUT (101a, 101b, 101c) via module connections (210a, 212a, 210b, 212b, 210c, 212c) and may also be connected to one or more strings (110) or sections of strings (110) (not shown in FIG. 6A for clarity) via string connections (214a, 216a, 214b, 216b, 214c, 216c) such that DUTs (101a, 101b, 101c) may operate in series within one or more strings (110). In one embodiment any of (200a, 200b, 200c) could also be connected together, for example by connecting (216a) to (214b) to connect output of (200a) to the input of (200b). In one embodiment (200a, 200b, 200c) could be disconnected from strings (110), i.e. (214a, 216a) could be disconnected, or (214b, 216b) could be disconnected, or (214c, 216c) could be disconnected, such that either (101a), (101b), or (101c) is effectively standalone and not in-line (in-situ) within a string (110).

Thus, each I-V unit (200a, 200b, 200c) is connected with an associated PV module DUT (101a, 101b, 101c) which it will measure, and the associated PV module DUTs (101a, 101b, 101c) in different embodiments may each be standalone, part of a particular string (110), or parts of different strings (110), and in some embodiments when DUTs (101a, 101b, 101c) associated with I-V units (200a, 200b, 200c) are in the same string (110) they may be in a sequential position within that string (110) (outputs connected to inputs, as described above) or in different positions with intervening modules (100).

In some embodiments leader (200a) coordinates sharing of data with followers (200b, 200c) to permit calculation of relative performance metrics.

For example, in one embodiment of the arrangement depicted in FIG. 6A, leader unit (200a) may be connected (associated) to a PV module DUT (101a) which is maintained in a clean state, by regular cleaning by site operations and maintenance personnel or by automated equipment, and follower units (200b, 200c) may be connected (associated) to DUTs (101b, 101c) which are permitted to be “soiled” (dirty) substantially the same as other modules (100) in the array, without cleaning, and leader (200a) and follower (200b, 200c) work together to determine relative performance metrics quantifying soiling power losses for soiled DUTs (101b, 101c) using clean DUT (101a) as a reference. In some embodiments, measurements performed by I-V unit (200a) for DUT (101a) may be used to determine a current, short-circuit current, power, maximum power, or an effective irradiance (short-circuit current normalized by a calibration constant and a temperature correction), for DUT (101a). The leader unit (200a) may then send these data to follower units over a network bus accessed via auxiliary connection (370a), allowing follower units (200b, 200c) to receive the data via auxiliary connections (370b, 370c) and to use the received data as a reference to determine a relative performance metric (such as a soiling ratio) of their connected (associated) PV module DUTs (101b, 101c). For example, followers (200b, 200c) could measure a current, short-circuit current, power, maximum power, or effective irradiance of their associated PV module DUTs (101b, 101c) and compare these values with reference values received from leader (200a) for DUT (101a) to determine a soiling ratio, a ratio of a performance parameter of a soiled module to a performance parameter that would be expected if the module were in a clean state.

Relative performance metrics could include soiling ratios, soiling losses, relative irradiance, relative power, degradation ratios, and others.

Controllers (300) within units (200a, 200b, 200c) perform the determination of relative performance metrics. For the purpose of determining relative performance metrics, in some embodiments the term “controller” is interchangeable with the term “processor.” The term “determines” means substantially the same as “calculate” or “computes”.

In some embodiments relative performance metrics are calculated using I-V data, which may include a portion of an I-V curve of an associated PV module ranging substantially from short-circuit to open-circuit, or a portion of an I-V curve of an associated PV module ranging substantially from voltages below maximum power point to above maximum power point, or a single point or a portion of an I-V curve of an associated PV module, or parameters extracted from an I-V curve of an associated PV module, including short-circuit current, open-circuit voltage, maximum power-point voltage, maximum power-point current, or maximum power, or a metric calculated from parameters extracted from an I-V curve of an associated PV module. In some embodiments I-V data may be based on a combination of any of the foregoing with stored or calculation calibration or correction constants.

In some embodiments of the arrangement depicted in FIG. 6A, I-V data is received by follower units (200b, 200c) from the leader unit (200a) and a user system reads results from the follower units (200b, 200c). In such embodiments, leader (200a) sends I-V data for DUT (101a); followers (200b, 200c) receive the data; followers (200b, 200c) measure I-V data for their associated DUTs (101b, 101c) and determine relative performance metrics for DUTs (101b, 101c) using reference I-V data for DUT (101a) received from leader (200a); and a user system reads the resulting relative performance metrics for DUTs (101b, 101c) from the follower I-V units (200b, 200c) via their main connection ports (350b, 350c) over cables (349b, 349c). (Some of these steps may proceed in different orders.) For example, in one embodiment DUT (101a) is maintained clean and serves as a reference for soiled DUTs (101b, 101c) and follower units (200b, 200c) determine soiling ratios for soiled DUTs (101b, 101c) using clean DUT (101a) as a reference.

In some embodiments of the arrangement depicted in FIG. 6A, I-V data is received by leader unit (200a) from the follower units (200b, 200c) and a user system reads all results from the leader unit (200a). In such embodiments, followers (200b, 200c) send I-V data for their associated DUTs (101b, 101c); leader (200a) receives the data; leader (200a) measures I-V data for its associated DUT (101a) and determines relative performance metrics for DUTs (101b, 101c) using I-V data for DUT (101a); and a user system reads the resulting relative performance metrics for DUTs (101b, 101c) from the leader I-V unit (200a) via its main connection port (350a) over cable (349a). (Some of these steps may proceed in different orders.) For example, in one embodiment DUT (101a) is maintained clean and serves as a reference for soiled DUTs (101b, 101c) and leader unit (200a) determines soiling ratios for soiled DUTs (101b, 101c) using clean DUT (101a) as a reference.

Therefore, in some embodiments, an I-V unit (200b or 200c) determines a relative performance metric for its own associated PV module (101b or 101c) using data received from another I-V unit (200a) that measures its associated PV module (101a), while in other embodiments an I-V unit (200a) determines relative performance metrics for multiple PV modules (101b, 101c) using data received from their associated I-V units (200b, 200c).

FIG. 6B depicts another embodiment, similar to embodiments depicted by FIG. 6A except that the main communication ports (350b, 350c) of follower I-V units (200b, 200c) are connected by a network bus to the auxiliary communication port (370a) of leader I-V unit (200a) via cables (371a, 371b), user connections (349b, 349c in FIG. 6A) to follower I-V units (200b, 200c) are omitted, and all data is read by the user system from leader I-V unit (200a) via its main port (350a) over cable (349a). In some embodiments, a user provides both power and communication signals to leader I-V unit (200a) which in turn provides both power and communication signals to follower I-V units (350b, 350c) via its auxiliary port (370a). Advantageously, this arrangement in some embodiments enables that a user provide only a single connection point for power and communication. As described in reference to embodiments depicted in FIG. 6A, relative performance metrics may be determined in any of the I-V units (200a, 200b, 200c), although in embodiments depicted in FIG. 6B all communication from the user is routed through leader unit (200a).

Therefore, in some embodiments, each I-V unit (200a, 200b, 200c) receives both power and user communication via main connections (350a, 350b, 350c), while in other embodiments, auxiliary port (370a) delivers both power and communication signals from I-V unit (200a) to I-V units (200b, 200c) via their main (350b, 350c) or auxiliary (370b, 370c) ports.

In some embodiments, I-V units (200a, 200b, 200c) are independently powered, for example by DUTs (101a, 101b, 101c).

In some embodiments, I-V units (200a, 200b, 200c) communicate wirelessly or over module or string connections or wiring.

In some embodiments data are shared between I-V units (200a, 200b, 200c) in both directions.

In some embodiments, data are shared between I-V units over the user's network or another network via main connections (350a, 350b, 350c).

FIG. 7 depicts schematically other embodiments employing multiple I-V units (200a, 200b) similar to the embodiment of FIG. 6A. However, in embodiments depicted by FIG. 7, a leader unit (200a) receives data from additional external/auxiliary devices (602) and/or (604) in addition to communicating with a follower unit (200b) and with additional follower units if present (such as (200c) depicted in FIG. 6A and FIG. 6B, etc). For example, leader unit (200a) may collect irradiance data from an irradiance sensor (604) and/or soiling data from an optical soiling sensor (602) (such as the Mars Optical Soiling Sensor, DUSST, DustIQ, or similar devices, described, respectively, in the following references, each of which is incorporated herein by reference: Gostein, Michael, et al. “Mars Soiling Sensor™”, 2018 IEEE 7th World Conference on Photovoltaic Energy Conversion (WCPEC) (A Joint Conference of 45th IEEE PVSC, 28th PVSEC & 34th EU PVSEC), IEEE, 2018; Korevaar, Marc, et al. “Novel soiling detection system for solar panels,” 33rd European Photovoltaic Solar Energy Conference and Exhibition, 2017; Fernandez-Solas, Álvaro, et al. “Design, characterization and indoor validation of the optical soiling detector “DUSST”, Solar Energy 211 (2020): 1459-1468). It may use the soiling data from the optical soiling sensor (602) to correct the reading of the irradiance sensor (604), yielding a more accurate irradiance measurement free of the influence of soiling particles. The leader unit (602) may then share these data with follower units over a network, as described in connection with FIG. 6A and FIG. 6B, allowing both the leader (200a) and follower units (200b) to use the irradiance as a reference to determine a relative performance metric of their connected (associated) PV module DUT (101a, 101b), such as performance metrics described above. While only two I-V units (200a, 200b) are depicted in FIG. 7 for simplicity, including one leader (200a) and one follower (200b), any number of leaders (200a) and/or followers (200b) could be used.

Depiction of main power and communication port (350) and auxiliary power and communication port (370) in the figures is exemplary. In various embodiments, a lesser or greater number of power and communication ports may be used and ports may have either equivalent or specialized functions.

In various embodiments, data sharing between multiple units (200a, 200b, 200c) is organized in different ways, proceeds in different directions, or is routed over different communication channels, and all such embodiments including the specific examples provided are within the scope of this disclosure.

In FIG. 6A, FIG. 6B, and FIG. 7, only two to three I-V units are depicted for simplicity, including one leader (200a) and two followers (200b, 200c); however, any number of leaders (200a) and/or followers (200b, 200c) could be used within the scope of this disclosure, and the terms leader and follower are exemplary as discussed above.

A device (200) according to the present disclosure may be referred to by various terms, including I-V unit, in-situ I-V unit, measurement unit, device, unit, etc., according to the context. In exemplary embodiments where a first unit such as (200b) receives data from a second unit such as (200a), the first unit (200b) may be referred to, for example, as a “device,” and the second unit (200a) may be referred to, for example, as an “external device.”

FIG. 1, FIG. 2A, FIG. 2B, and FIG. 3 depict a single device according to the present disclosure. FIG. 6A, FIG. 6B, and FIG. 7 depict a system of devices according to the present disclosure. Therefore, disclosed herein is both a device and a system. A device with the functions described herein which supports integration as a system in the manner described, or a system which relies on devices with the functions described, are both within the scope of this disclosure.

Concepts, processes, and components described in this disclosure could be used in different combinations, sequences, or pluralities and each such combination, sequence, or plurality is within the scope of this disclosure. In alternative embodiments a device or method according to the present disclosure could be divided into multiple devices or steps each having a portion of the functions described, combined into a larger device or sequence of steps having additional functions, or duplicated to serve in parallel or series fashion.

Aspects of the disclosed subject matter are described in the following respects.

In one respect, disclosed is a device for measuring current-voltage characteristics of at least one photovoltaic (PV) module connected to a photovoltaic array powering a load or inverter.

In another respect, disclosed is an in-situ current-voltage (I-V) measurement device for photovoltaic modules, comprising a variable load, wherein said variable load is configured to be connected in parallel with a module, wherein said module is connected in series with at least one other module in a string, such that said module supplies current simultaneously to said string and to said variable load, and wherein said variable load is controlled by a controller, and wherein said controller is configured to shift an I-V operating point of said module, based at least upon varying said variable load.

In another respect, said operating point shifts towards higher current as a current of said variable load is increased.

In another respect, a module current of said module comprises a combination of a string current of said string and a variable load current of said variable load.

In another respect, a device according to the present disclosure comprises a module current measurement circuit and a module voltage measurement circuit, wherein said controller is configured to measure at least a portion of an I-V curve of said module based at least upon varying a variable load current of said variable load and recording readings from said module current measurement circuit and said module voltage measurement circuit.

In another respect, in a pass-through operation mode of said device, said controller configures said variable load to draw substantially zero current from said module.

In another respect, a device according to the present disclosure comprises module connections configured to connect said device to said module and string connections configured to connect said device to said string.

In another respect, a device according to the present disclosure comprises a coupling circuit connecting said module connections to said string connections.

In another respect, said coupling circuit is configured as a DC-DC switching power converter, comprising at least a release transistor configured to alternately enable and disable current flow, wherein a duty cycle of said release transistor is controlled by said controller, and wherein said controller is configured to shift said operating point of said module based at least upon varying said duty cycle.

In another respect, said operating point of said module shifts towards lower current as said duty cycle is reduced.

In another respect, a device according to the present disclosure comprises a module current measurement circuit and a module voltage measurement circuit, wherein said controller is configured to measure at least a portion of an I-V curve of said module based at least upon varying said duty cycle and recording readings from said current measurement circuit and said voltage measurement circuit.

In another respect, in a pass-through operation mode of said device, said controller configures said duty cycle to 100%, continuously enabling said current flow through said release transistor.

In another respect, said controller configures said duty cycle at a fixed value less than 100% and varies said current of said variable load to shift said I-V operating point along an I-V curve of said module.

In another respect, a device according to the present disclosure comprises a module current measurement circuit and a module voltage measurement circuit, wherein said controller is configured to measure at least a portion of said I-V curve based at least upon varying a variable load current through said variable load, varying said duty cycle, and recording readings from said current measurement circuit and said voltage measurement circuit.

In one respect, disclosed is a method of measuring at least a portion of a current-voltage (I-V) curve for a photovoltaic module in-situ within a photovoltaic array, comprising connecting a variable load in parallel with said module, wherein said module is connected in series with at least one other module in a string, allowing said module to supply current simultaneously to said string and to said variable load, and varying said variable load to shift an I-V operating point of said module.

In another respect, a method according to the present disclosure comprises measuring a module current of said module with a module current measurement circuit, measuring a voltage of said module with a voltage measurement circuit, varying said variable load, and recording readings from said module current measurement circuit and said voltage measurement circuit.

In another respect, a method according to the present disclosure comprises, in a pass-through operation mode, configuring said variable load to draw substantially zero current from said module.

In another respect, a method according to the present disclosure comprises connecting a coupling circuit between said module and said string, wherein said coupling circuit is configured as a DC-DC switching power converter, comprising at least a release transistor configured to alternately enable and disable current flow, and varying a duty cycle of said release transistor to shift said operating point of said module based at least upon varying said duty cycle.

In another respect, a method according to the present disclosure comprises shifting said operating point towards lower current by reducing said duty cycle.

In another respect, a method according to the present disclosure comprises measuring a module current of said module with a module current measurement circuit, measuring a voltage of said module with a voltage measurement circuit, varying said variable load and/or said duty cycle, and recording readings from said module current measurement circuit and said voltage measurement circuit.

Additional aspects of the disclosed subject matter are described in the following respects.

In one respect, disclosed is a device (200, 200a, 200b, 200c) comprising terminals or connections (209, 211, 213, 215, 210, 212, 214, 216) configured to connect to a first associated PV module (101, 101a, 101b, 101c), I-V measurement circuitry (at least (220, 222), and in some embodiments (250) and/or (230)) coupled to said terminals or connections and configured to measure I-V data of said first associated PV module, communication circuitry (within or coupled to controller (300), including, in some embodiments (352) or (356) or (360)), configured to communicate with at least one external device (as depicted in FIG. 6A, FIG. 6B, or FIG. 7), and a processor (equivalently, a controller (300), (304), or (302), wherein in some embodiments a processor is a function of a controller or a controller is a function of a processor) coupled to said I-V measurement circuitry and to said communication circuitry, wherein said processor is configured to receive external data via said communication circuitry from said at least one external device (as depicted in FIG. 6A, FIG. 6B, or FIG. 7), and wherein said processor is configured to determine a relative performance metric based at least upon said I-V data of said first associated PV module and said external data.

In another respect, said I-V data of said first associated PV module comprises at least a portion of an I-V curve of said first associated PV module or a metric calculated at least therefrom (as depicted in FIG. 4A, FIG. 4B, FIG. 4C, FIG. 4D, or FIG. 4E, including parameters and metrics depicted therein and parameters and metrics based at least upon those depicted).

In another respect, said external data comprises I-V data of a second associated PV module connected to said external device (wherein in some embodiments said external device is substantially similar to said device (200, 200a, 200b, 200c).

In another respect, said I-V data of said second associated PV module comprises at least a portion of an I-V curve of said second associated PV module or a metric calculated at least therefrom (as depicted in FIG. 4A, FIG. 4B, FIG. 4C, FIG. 4D, or FIG. 4E, including parameters and metrics depicted therein and parameters and metrics based at least upon those depicted).

In another respect, said relative performance metric comprises a comparison of a value based at least upon said I-V data of said first associated PV module and said I-V data of said second associated PV module. In some embodiments this comprises a metric based at least upon a current, voltage, or power of said first associated PV module and a current, voltage, or power of said second associated PV module.

In another respect, said relative performance metric quantifies relative cleanliness of said first associated PV module or said second associated PV module. For example, in some embodiments the relative performance metric is a soiling ratio, quantifying the output of a PV module in an unknown state of cleanliness relative to its expected output if it were clean, or a soiling loss, quantifying the loss in output of a PV module in an unknown state of cleanliness relative to its expected output if it were clean.

In another respect, said external device comprises an irradiance sensor (as depicted in FIG. 7).

In another respect, said external device comprises a soiling sensor (as depicted in FIG. 7).

In another respect, said device is configured to power said external device (in some embodiments, via (362)).

In one respect, disclosed is a system comprising a first device configured to measure first I-V data of a first associated PV module, and a second device configured to measure second I-V data of a second associated PV module, wherein said first device may be configured to receive said second I-V data and to determine a relative performance metric based at least upon said second I-V data and said first I-V data (as depicted in FIG. 6A, FIG. 6B, or FIG. 7). In some embodiments, said first device and said second device are substantially similar or even identical, and said first device may be configured by a technician or a user, for example via software settings, to operate in a state where it receives said second I-V data and determines said relative performance metric.

In another respect, said first I-V data comprises at least a portion of an I-V curve of said first associated PV module or a metric calculated at least therefrom and said second I-V data comprises at least a portion of an I-V curve of said second associated PV module or a metric calculated at least therefrom (as depicted in FIG. 4A, 4B, 4C, 4D. or 4E).

In another respect, said relative performance metric quantifies cleanliness of said first associated PV module or said second associated PV module (wherein said relative performance metric is a soiling ratio or a soiling loss).

In another respect, said first device may be configured to power said second device or said second device may be configured to power said first device (for example in some embodiments via (362)).

1. A device comprising
terminals or connections configured to connect to a first associated PV module,
I-V measurement circuitry coupled to said terminals or connections and configured to measure I-V data of said first associated PV module,
communication circuitry configured to communicate with at least one external device, and
a processor coupled to said I-V measurement circuitry and to said communication circuitry,
wherein
said processor is configured to receive external data via said communication circuitry from said at least one external device, and
wherein
said processor is configured to determine a relative performance metric based at least upon said I-V data of said first associated PV module and said external data.

2. The device of claim 37, wherein said I-V data of said first associated PV module comprises at least a portion of an I-V curve of said first associated PV module or a metric calculated at least therefrom.

3. The device of claim 37, wherein said external data comprises I-V data of a second associated PV module connected to said external device.

4. The device of claim 3, wherein said I-V data of said second associated PV module comprises at least a portion of an I-V curve of said second associated PV module or a metric calculated at least therefrom.

5. The device of claim 3, wherein said relative performance metric comprises a comparison of a value based at least upon said I-V data of said first associated PV module and said I-V data of said second associated PV module.

6. The device of claim 1, wherein said relative performance metric quantifies relative cleanliness of said first associated PV module or said second associated PV module.

7. The device of claim 1, wherein said external device comprises an irradiance sensor.

8. The device of claim 1, wherein said external device comprises a soiling sensor.

9. The device of claim 1, wherein said device is configured to power said external device.

10. A system comprising
a first device configured to measure first I-V data of a first associated PV module, and
a second device configured to measure second I-V data of a second associated PV module,
wherein said first device may be configured to receive said second I-V data and to determine a relative performance metric based at least upon said second I-V data and said first I-V data.

11. The system of claim 10, wherein said first I-V data comprises at least a portion of an I-V curve of said first associated PV module or a metric calculated at least therefrom and said second I-V data comprises at least a portion of an I-V curve of said second associated PV module or a metric calculated at least therefrom.

12. The system of claim 10, wherein said relative performance metric quantifies cleanliness of said first associated PV module or said second associated PV module.

13. The system of claim 10, wherein said first device may be configured to power said second device or said second device may be configured to power said first device.
